(19) United States
(12) Patent Application Publication
(10) Pub. No.: US 2024/0202970 A1
(43) Pub. Date: Jun. 20, 2024

(54) OBJECT ANGLE DETECTION

(71) Applicant: Ford Global Technologies, LLC, Dearborn, MI (US)

(72) Inventors: Kunle Olutomilayo, Newark, CA (US); Vijay Nagasamy, Fremont, CA (US); Hongtei Eric Tseng, Canton, MI (US); Darrel Alan Recker, Ypsilanti, MI (US)

(73) Assignee: Ford Global Technologies, LLC, Dearborn, MI (US)

(21) Appl. No.: 18/066,340

(22) Filed: Dec. 15, 2022

(51) Int. Cl. G06T 7/73; G01B 11/27; G06T 7/66

(52) U.S. Cl. CPC G06T 7/74; G01B 11/272; G06T 7/66; G06T 2207/30204; G06T 2207/30252

(57) ABSTRACT

A system is disclosed that includes a computer and memory, the memory including instructions to acquire images, including a first image and a second image of an object attached to a platform that is moving and determine a first real world location of a fiducial marker and a second location of the fiducial marker. A center of rotation for the object can be determined by tracking the first and second real world locations of the fiducial marker and an angle of an axis the object with respect to an axis of the platform can be determined based on the center of rotation, the tracked locations of the fiducial marker, and calibration data.

### BACKGROUND

Images can be acquired by sensors and processed using a computer to determine data regarding objects in an environment around a system. Operation of a sensing system can include acquiring accurate and timely data regarding objects in the system's environment. A computer can acquire images from one or more image sensors that can be processed to determine data regarding objects. Data extracted from images of objects can be used by a computer to operate systems including vehicles, robots, security systems, and/or object tracking systems.

### BRIEF DESCRIPTION OF THE DRAWINGS

FIG. 1 is a block diagram of an example traffic infrastructure system.

FIG. 2 is a diagram of an example vehicle including a reference plane.

FIG. 3 is a diagram of an example fiducial marker.

FIG. 4 is a diagram of an example trailer.

FIG. 5 is a diagram of an example trailer attached to a vehicle.

FIG. 6 is a diagram of another example trailer attached to a vehicle.

FIG. 7 is a diagram of a further example trailer attached to a vehicle.

FIG. 8 is a diagram of determined trailer arcs.

FIG. 9 is a flowchart diagram of an example process to determine a trailer angle.

FIG. 10 is a flowchart diagram of an example process to operate a vehicle based on a determined trailer angle.

### DETAILED DESCRIPTION

A system as described herein can be used to locate objects in an environment around the system and operate the system based on the location of the objects. Typically, sensor data can be provided to a computer to locate an object and determine a system trajectory based on the location of the object. A trajectory is a set of locations that can be indicated as coordinates in a coordinate system that along with velocities, e.g., vectors indicating speeds and headings, at respective locations. A computer in a system can determine a trajectory for operating the system that locates the system or portions of the system with respect to the object. A vehicle is described herein as an example of a system that includes a sensor to acquire data regarding an object, a computer to process the sensor data and controllers to operate the vehicle based on output from the computer. Other systems that can include sensors, computers and controllers that can respond to objects in an environment around the system include robots, security systems and object tracking systems.

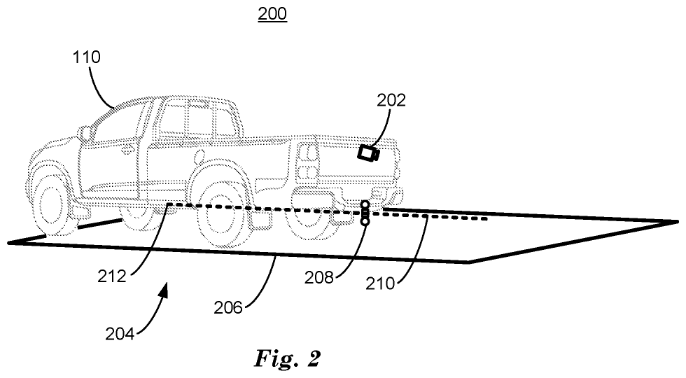

A non-limiting example of an object that can be located with respect to a vehicle is a trailer. A trailer is a wheeled, typically unpowered platform that can be towed behind a vehicle. A trailer can be attached to a vehicle by positioning a trailer hitch coupler onto a vehicle hitch ball. A trailer attached to a vehicle using a hitch coupler/hitch ball can be towed behind the vehicle while permitting the vehicle and attached trailer to pivot at the hitch coupler/hitch ball point. Pivoting at the hitch coupler/hitch ball point permits the vehicle and attached trailer to maneuver, e.g., back up and park the trailer at a selected location. Maneuvering a vehicle with an attached trailer can require determining a trailer angle as will be described in relation to FIGS. 2-8, below. A trailer angle can be determined by determining an angle between a vehicle axis and a trailer axis, where the vehicle axis and the trailer axis intersect at the location of the hitch coupler/hitch ball.

A neural network can be used to determine a trailer angle. The neural network can be trained to process an image that includes a trailer hitch coupler/hitch ball attachment point to determine a trailer angle. An issue with determining a trailer angle with neural networks is that the result is sensitive to the height of the hitch coupler/hitch ball with respect to the ground plane. The ground plane is a plane that coincides with the roadway or pavement that supports the wheels of the vehicle and trailer. If the vehicle includes an adjustable hitch ball that can be moved up or down to match the hitch coupler height of a particular trailer, a trained neural network can yield incorrect trailer angle results if the height of the hitch ball is different than the height at which the neural network was trained. In some examples, a difference in tire size or inflation can cause a height difference that can cause a neural network to output an incorrect result for trailer angle.

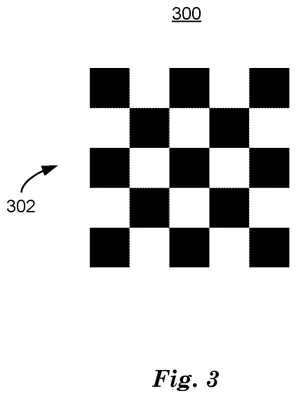

Techniques discussed herein describe fiducial marker-based trailer angle estimation. Fiducial marker-based trailer angle estimation determines a trailer angle by using image processing techniques to locate a fiducial marker attached to a trailer. The fiducial marker location is combined with calibration data determined based on previously determined locations of the fiducial marker to determine a trailer angle independently of the height of the hitch coupler/hitch ball with respect to a ground plane. A fiducial marker is a pattern that is attached to a trailer that can be readily located using image processing software as described below in relation to FIG. 3. Fiducial marker-based trailer angle estimation can enhance determination of a trailer angle by requiring fewer computing resources than neural network-based techniques and being robust with respect to changes in trailer hitch height and longitudinal location with respect to a vehicle.

A method is disclosed herein including acquiring images, including a first image and a second image of an object attached to a platform that is moving, determining a first real world location of a fiducial marker included in the object by determining a first location of the fiducial marker in first pixel coordinates of the first image, and projecting the first pixel coordinates onto a reference plane, determining a second real world location of a fiducial marker included in the object by determining a second location of the fiducial marker in second pixel coordinates of the second image, and projecting the second pixel coordinates onto the reference plane, determining a center of rotation for the object by fitting the first and second real world locations of the fiducial marker to an arc and determining an angle of an axis the object with respect to an axis of the platform based on the center of rotation, a third location of the fiducial marker, and calibration data. The center of rotation for the object can be determined by fitting the first and second real world locations of the fiducial marker while moving the platform to change the angle of the axis of the object with respect to the axis of the platform. The center of rotation can be determined by fitting the first and second real world locations of the fiducial marker to an arc using a least squares technique.

The calibration data can include an offset angle between the location of the fiducial marker and the axis of the object. When it is determined that the calibration data does not exist, the calibration data can be determined by acquiring one or more images of the fiducial marker while moving the platform forward in a straight line to determine the offset angle between the location of the fiducial marker and the axis of the object. The axis of the object can be parallel to a direction of forward motion and passes through the center of rotation. The axis of the platform can be parallel to a direction of forward motion and passes through the center of rotation. The center of rotation can be coincident with a point of attachment between the object and the platform. The real world locations of the fiducial marker can be determined with respect to a reference plane specified parallel to a roadway or pavement surface upon which the platform moves. The platform can be a vehicle and moving the platform can include the computer controlling one or more of vehicle powertrain, vehicle steering and vehicle brakes. The object can be attached to the platform with a hitch ball that adjusts up and down. The object can be a vehicle trailer. The fiducial marker can be one or more of a checkerboard pattern and an ArUco pattern. Moving the platform to change the angle of the axis of the object with respect to the axis of the platform can include moving the platform backwards.

Further disclosed is a computer readable medium, storing program instructions for executing some or all of the above method steps. Further disclosed is a computer programmed for executing some or all of the above method steps, including a computer apparatus, programmed to acquire images, including a first image and a second image of an object attached to a platform that is moving, determine a first real world location of a fiducial marker included in the object by determining a first location of the fiducial marker in first pixel coordinates of the first image, and projecting the first pixel coordinates onto a reference plane, determine a second real world location of a fiducial marker included in the object by determining a second location of the fiducial marker in second pixel coordinates of the second image, and projecting the second pixel coordinates onto the reference plane, determining a center of rotation for the object by fitting the first and second real world locations of the fiducial marker to an arc and determining an angle of an axis the object with respect to an axis of the platform based on the center of rotation, a third location of the fiducial marker, and calibration data. The center of rotation for the object can be determined by fitting the first and second real world locations of the fiducial marker while moving the platform to change the angle of the axis of the object with respect to the axis of the platform. The center of rotation can be determined by fitting the first and second real world locations of the fiducial marker to an arc using a least squares technique.

The instructions can include further instructions wherein the calibration data can include an offset angle between the location of the fiducial marker and the axis of the object. When it is determined that the calibration data does not exist, the calibration data can be determined by acquiring one or more images of the fiducial marker while moving the platform forward in a straight line to determine the offset angle between the location of the fiducial marker and the axis of the object. The axis of the object can be parallel to a direction of forward motion and passes through the center of rotation. The axis of the platform can be parallel to a direction of forward motion and passes through the center of rotation. The center of rotation can be coincident with a point of attachment between the object and the platform. The real world locations of the fiducial marker can be determined with respect to a reference plane specified parallel to a roadway or pavement surface upon which the platform moves. The platform can be a vehicle and moving the platform can include the computer controlling one or more of vehicle powertrain, vehicle steering and vehicle brakes. The object can be attached to the platform with a hitch ball that adjusts up and down. The object can be a vehicle trailer. The fiducial marker can be one or more of a checkerboard pattern and an ArUco pattern. Moving the platform to change the angle of the axis of the object with respect to the axis of the platform can include moving the platform backwards.

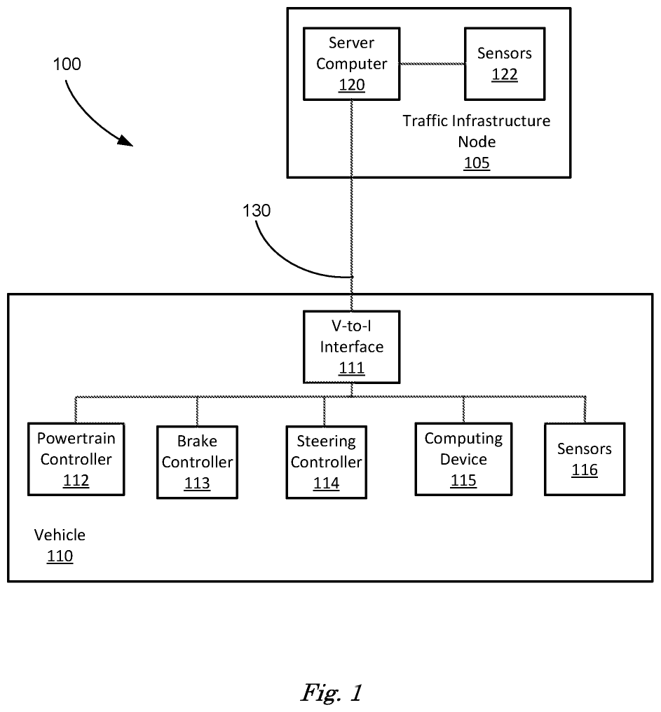

FIG. 1 is a diagram of a sensing system 100 that can include a traffic infrastructure node 105 that includes a server computer 120 and stationary sensors 122. Sensing system 100 includes a vehicle 110, operable in autonomous (“autonomous” by itself in this disclosure means “fully autonomous”), semi-autonomous, and occupant piloted (also referred to as non-autonomous) mode. One or more vehicle 110 computing devices 115 can receive data regarding the operation of the vehicle 110 from sensors 116. The computing device 115 may operate the vehicle 110 in an autonomous mode, a semi-autonomous mode, or a non-autonomous mode.

The computing device 115 includes a processor and a memory such as are known. Further, the memory includes one or more forms of computer-readable media, and stores instructions executable by the processor for performing various operations, including as disclosed herein. For example, the computing device 115 may include programming to operate one or more of vehicle brakes, propulsion (i.e., control of acceleration in the vehicle 110 by controlling one or more of an internal combustion engine, electric motor, hybrid engine, etc.), steering, climate control, interior and/or exterior lights, etc., as well as to determine whether and when the computing device 115, as opposed to a human operator, is to control such operations.

The computing device 115 may include or be communicatively coupled to, i.e., via a vehicle communications bus as described further below, more than one computing devices, i.e., controllers or the like included in the vehicle 110 for monitoring and/or controlling various vehicle components, i.e., a powertrain controller 112, a brake controller 113, a steering controller 114, etc. The computing device 115 is generally arranged for communications on a vehicle communication network, i.e., including a bus in the vehicle 110 such as a controller area network (CAN) or the like; the vehicle 110 network can additionally or alternatively include wired or wireless communication mechanisms such as are known, i.e., Ethernet or other communication protocols.

Via the vehicle network, the computing device 115 may transmit messages to various devices in the vehicle and/or receive messages from the various devices, i.e., controllers, actuators, sensors, etc., including sensors 116. Alternatively, or additionally, in cases where the computing device 115 actually comprises multiple devices, the vehicle communication network may be used for communications between devices represented as the computing device 115 in this disclosure. Further, as mentioned below, various controllers or sensing elements such as sensors 116 may provide data to the computing device 115 via the vehicle communication network.

In addition, the computing device 115 may be configured for communicating through a vehicle-to-infrastructure (V2X) interface 111 with a remote server computer 120, i.e., a cloud server, via a network 130, which, as described below, includes hardware, firmware, and software that permits computing device 115 to communicate with a remote server computer 120 via a network 130 such as wireless Internet (WI-FI®) or cellular networks. V2X interface 111 may accordingly include processors, memory, transceivers, etc., configured to utilize various wired and/or wireless networking technologies, i.e., cellular, BLUETOOTH®, Bluetooth Low Energy (BLE), Ultra-Wideband (UWB), Peer-to-Peer communication, UWB based Radar, IEEE 802.11, and/or other wired and/or wireless packet networks or technologies. Computing device 115 may be configured for communicating with other vehicles 110 through V2X (vehicle-to-everything) interface 111 using vehicle-to-vehicle (V-to-V) networks, i.e., according to including cellular communications (C-V2X) wireless communications cellular, Dedicated Short Range Communications (DSRC) and/or the like, i.e., formed on an ad hoc basis among nearby vehicles 110 or formed through infrastructure-based networks. The computing device 115 also includes nonvolatile memory such as is known. Computing device 115 can log data by storing the data in nonvolatile memory for later retrieval and transmittal via the vehicle communication network and a vehicle to infrastructure (V2X) interface 111 to a server computer 120 or user mobile device 160.

As already mentioned, generally included in instructions stored in the memory and executable by the processor of the computing device 115 is programming for operating one or more vehicle 110 components, i.e., braking, steering, propulsion, etc., without intervention of a human operator. Using data received in the computing device 115, i.e., the sensor data from the sensors 116, the server computer 120, etc., the computing device 115 may make various determinations and/or control various vehicle 110 components and/or operations without a driver to operate the vehicle 110. For example, the computing device 115 may include programming to regulate vehicle 110 operational behaviors (i.e., physical manifestations of vehicle 110 operation) such as speed, acceleration, deceleration, steering, etc., as well as tactical behaviors (i.e., control of operational behaviors typically in a manner intended to achieve efficient traversal of a route) such as a distance between vehicles and/or amount of time between vehicles, lane-change, minimum gap between vehicles, left-turn-across-path minimum, time-to-arrival at a particular location and intersection (without signal) minimum time-to-arrival to cross the intersection.

Controllers, as that term is used herein, include computing devices that typically are programmed to monitor and/or control a specific vehicle subsystem. Examples include a powertrain controller 112, a brake controller 113, and a steering controller 114. A controller may be an electronic control unit (ECU) such as is known, possibly including additional programming as described herein. The controllers may communicatively be connected to and receive instructions from the computing device 115 to actuate the subsystem according to the instructions. For example, the brake controller 113 may receive instructions from the computing device 115 to operate the brakes of the vehicle 110.

The one or more controllers 112, 113, 114 for the vehicle 110 may include known electronic control units (ECUs) or the like including, as non-limiting examples, one or more powertrain controllers 112, one or more brake controllers 113, and one or more steering controllers 114. Each of the controllers 112, 113, 114 may include respective processors and memories and one or more actuators. The controllers 112, 113, 114 may be programmed and connected to a vehicle 110 communications bus, such as a controller area network (CAN) bus or local interconnect network (LIN) bus, to receive instructions from the computing device 115 and control actuators based on the instructions.

Sensors 116 may include a variety of devices known to provide data via the vehicle communications bus. For example, a radar fixed to a front bumper (not shown) of the vehicle 110 may provide a distance from the vehicle 110 to a next vehicle in front of the vehicle 110, or a global positioning system (GPS) sensor disposed in the vehicle 110 may provide geographical coordinates of the vehicle 110. The distance(s) provided by the radar and/or other sensors 116 and/or the geographical coordinates provided by the GPS sensor may be used by the computing device 115 to operate the vehicle 110 autonomously or semi-autonomously, for example.

The vehicle 110 is generally a land-based vehicle 110 capable of autonomous and/or semi-autonomous operation and having three or more wheels, i.e., a passenger car, light truck, etc. The vehicle 110 includes one or more sensors 116, the V2X interface 111, the computing device 115 and one or more controllers 112, 113, 114. The sensors 116 may collect data related to the vehicle 110 and the environment in which the vehicle 110 is operating. By way of example, and not limitation, sensors 116 may include, i.e., altimeters, cameras, LIDAR, radar, ultrasonic sensors, infrared sensors, pressure sensors, accelerometers, gyroscopes, temperature sensors, pressure sensors, hall sensors, optical sensors, voltage sensors, current sensors, mechanical sensors such as switches, etc. The sensors 116 may be used to sense the environment in which the vehicle 110 is operating, i.e., sensors 116 can detect phenomena such as weather conditions (precipitation, external ambient temperature, etc.), the grade of a road, the location of a road (i.e., using road edges, lane markings, etc.), or locations of target objects such as neighboring vehicles 110. The sensors 116 may further be used to collect data including dynamic vehicle 110 data related to operations of the vehicle 110 such as velocity, yaw rate, steering angle, engine speed, brake pressure, oil pressure, the power level applied to controllers 112, 113, 114 in the vehicle 110, connectivity between components, and accurate and timely performance of components of the vehicle 110.

Vehicles can be equipped to operate in autonomous, semi-autonomous, or manual modes. By a semi- or fully-autonomous mode, we mean a mode of operation wherein a vehicle can be piloted partly or entirely by a computing device as part of a system having sensors and controllers. For purposes of this disclosure, an autonomous mode is defined as one in which each of vehicle propulsion (i.e., via a powertrain including an internal combustion engine and/or electric motor), braking, and steering are controlled by one or more vehicle computers; in a semi-autonomous mode the vehicle computer(s) control(s) one or more of vehicle propulsion, braking, and steering. In a non-autonomous mode, none of these are controlled by a computer. In a semi-autonomous mode, some but not all of them are controlled by a computer.

A traffic infrastructure node 105 can include a physical structure such as a tower or other support structure (i.e., a pole, a box mountable to a bridge support, cell phone tower, road sign support, etc.) on which infrastructure sensors 122, as well as server computer 120, can be mounted, stored, and/or contained, and powered, etc. One traffic infrastructure node 105 is shown in FIG. 1 for case of illustration, but the system 100 could and likely would include tens, hundreds, or thousands of traffic infrastructure nodes 105. The traffic infrastructure node 105 is typically stationary, i.e., fixed to and not able to move from a specific geographic location. The infrastructure sensors 122 may include one or more sensors such as described above for the vehicle 110 sensors 116, i.e., lidar, radar, cameras, ultrasonic sensors, etc. The infrastructure sensors 122 are fixed or stationary. That is, each sensor 122 is mounted to the infrastructure node so as to have a substantially unmoving and unchanging field of view.

Server computer 120 typically has features in common, i.e., a computer processor and memory and configuration for communication via a network 130, with the vehicle 110 V2X interface 111 and computing device 115, and therefore these features will not be described further to avoid redundancy. Although not shown for ease of illustration, the traffic infrastructure node 105 also includes a power source such as a battery, solar power cells, and/or a connection to a power grid. A traffic infrastructure node 105 server computer 120 and/or vehicle 110 computing device 115 can receive sensor 116, 122 data to monitor one or more objects. An “object,” in the context of this disclosure, is a physical, i.e., material, structure or thing that can be detected by a vehicle sensor 116 and/or infrastructure sensor 122.

FIG. 2 is a diagram of a traffic scene 200. Traffic scene 200 includes a vehicle 110 as it operates on a supporting surface 204 which can be, for example, a roadway, pavement, a parking lot, or a floor included in a parking garage or other structure. Vehicle 110 can include a camera 202, which can be a video camera. As discussed above in relation to FIG. 1, a vehicle 110 can include a sensor 116, in this example a camera 202 that can acquire data regarding an environment around the vehicle 110. Vehicle 110 can include variety of sensors 116 including one or more of a lidar sensor, a radar sensor, or an ultrasound sensor to acquire data regarding an environment around the vehicle 110. A computing device 115 in the vehicle 110 can receive as input data acquired by camera 202 and process the data to determine the location of a reference plane 206 that is coincident with the supporting surface 204 upon which the vehicle 110 is located. A reference plane 206 can be described by an equation of the form P=ax+by+c that defines a plane that approximates the supporting surface 204. The location of the reference plane 206 with respect to the camera 202 can be determined in a real world 3D coordinate system.

Vehicle 110 can include a hitch ball 208 that is operative to connect to a hitch coupler to attach a trailer to vehicle 110. A hitch ball 208 is typically connected to the vehicle 110 behind the vehicle on a vehicle axis 210. A vehicle axis 210 can be determined by drawing a line parallel to a reference plane 206 from the center 212 of the vehicle 110 through the hitch ball 208. The center 212 of the vehicle can be determined by finding the center of a rectangle formed by the four wheels of the vehicle, for example. As discussed above, a hitch ball 208 typically will remain in line with the vehicle axis 210 while being adjusted up and down, e.g., perpendicular to the reference plane 206 to accommodate trailers having different height hitch couplers. Adjusting a hitch ball 208 up and down can permit trailers having different height hitch couplers to be level while being towed.

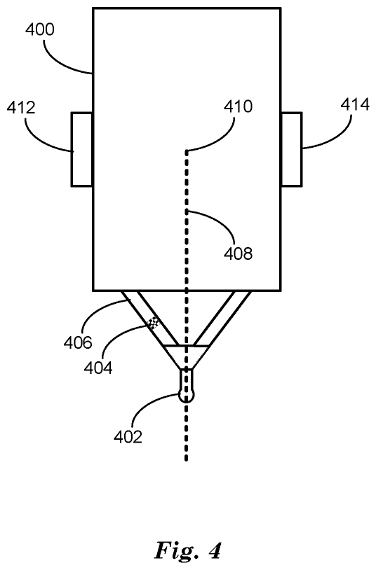

FIG. 3 is a diagram of an example fiducial marker 300. Fiducial marker 300 includes a checkerboard pattern 302. The checkerboard pattern 302 is useful because there exist image processing library routines to determine the pose of checkerboard patterns in an image. Pose includes both location and orientation, e.g., x and y coordinates, and roll rotation in the x, y plane. One such image processing library routine is “detectCheckerboardPoints”, included in the MATLAB image processing library, available from Math Works, Natick, MA 01760. Other pattern that can be included in a fiducial marker 300 are ArUco markers, which can be detected using the OpenCV open source computer vision library, available at OpenCV.org as of the filing date of this application. Techniques disclosed herein for determining trailer angles by attaching a fiducial marker 300 to a trailer will be discussed in relation to FIGS. 4-8, below.

As discussed above, a neural network can be trained to determine a trailer angle. An issue with training a neural network to determine trailer angles is that the network needs to be retrained when the camera 202 position and orientation changes with respect to the vehicle 110. The time and effort required to retrain the network can be significant. Neural network-based techniques for trailer angle detection (TAD) have not considered robustness issues with adjustable hitch balls 208. These hitch types permit adjustment of a hitch ball's 208 height and its longitudinal position along the vehicle axis 210. Adjusting the hitch ball 208 height and its longitudinal position can cause neural network-based TAD techniques to fail. In addition, neural network-based TAD techniques can be trained to process images based on trailer parts such as the trailer tongue, hitch coupler, and chains. Because of this, neural network-based TAD techniques tend fail when presented with previously unseen trailer types including previously unseen trailer parts. Determining a trailer angle using techniques discussed herein based on detecting a fiducial marker can overcome issues with hitch ball 208 adjustment and previously unseen trailers.

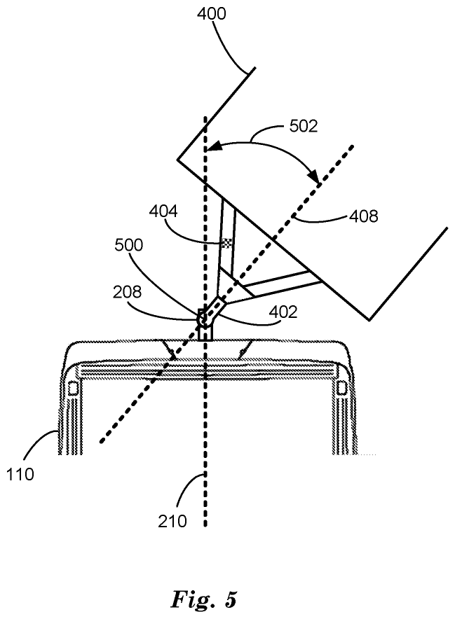

FIG. 4 is a diagram of an example trailer 400. Trailer includes a hitch coupler 402 and a fiducial marker 404 attached to one of the arms of the trailer tongue 406. The fiducial marker 404 can be a printed sticker that is adhesively attached to the trailer tongue 406, for example. Trailer 400 can also include a trailer axis 408. Trailer axis 408 can be a line determined based on the hitch coupler 402 and a trailer center point 410. The trailer center point 410 can be determined by determining a center point between trailer wheels 412, 414, for example. The trailer axis 408 will be used to determine a trailer angle with respect to a vehicle axis 210 as illustrated in FIG. 5, below.

FIG. 5 is a diagram of an example trailer 400 attached to a vehicle 110. Trailer 400 can be attached to vehicle 110 by positioning hitch coupler 402 onto hitch ball 208. Fiducial marker 404 included in trailer 400 can be viewed by camera 202 of FIG. 2. Vehicle axis 210 and trailer axis 408 cross at hitch center 500. Hitch center 500 is the location where the hitch coupler 402 and hitch ball 208 coincide when the trailer 400 is attached to the vehicle 110 and is the center of rotation for the trailer 400 with respect to the vehicle 110. Vehicle axis 210 and trailer axis 408 form a trailer angle 502 with respect to the hitch center 500.

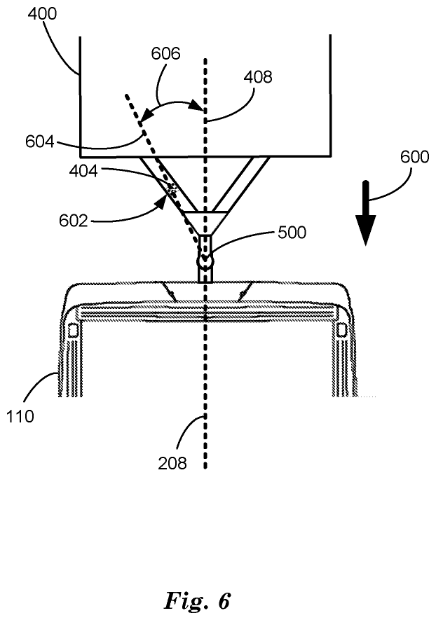

FIG. 6 is a diagram of a trailer 400 attached to a vehicle 110. FIG. 6 illustrates how fiducial marker-based trailer angle estimation is calibrated. To calibrate fiducial marker-based trailer angle estimation, the vehicle 110 is operated along a straight line path in a direction indicated by the arrow 600. The straight line path is parallel to the vehicle axis 210 and will pull the trailer 400 into alignment with the vehicle so that the trailer axis 408 aligns with the vehicle axis 210. One or more images of the trailer 400 including the fiducial marker 404 is acquired by the camera 202 and processed with image processing software included in a computing device 115 included in vehicle 110 as discussed in relation to FIG. 3 to locate the fiducial marker 404. When the plurality of images are acquired, the images can be filtered to average out small variations in the fiducial marker location due to random movements of the trailer as it is being towed along the straight line path to determine a fiducial marker straight-line location 602. The fiducial marker straight-line location 602 can be combined with the hitch center 500 to determine a fiducial marker offset line 604 (dashed line).

The fiducial marker straight-line location 602 can be projected onto the reference plane 206 determined as discussed in relation to FIG. 2 to determine the location of the fiducial marker 404 in real world coordinates with respect to the camera 202. The reference plane 206 is fixed in space during vehicle 110 production and can be determined to be the ground plane which supports the vehicle 110. The reference plane 206 is not guaranteed to remain coincident with the ground plane after production due to changes such as tire pressure variation or tire size variation, for example. However, as an advantage for fiducial marker-based trailer angle estimation, the reference plane 206 can be assumed to remain fixed in space after production without affecting the trailer angle estimation performance. The fiducial marker offset line 604 in indicates an offset angle 606 measured in real world coordinates from the trailer axis 408. The offset angle 606 remains unchanged despite changes in trailer height with respect to the vehicle 110.

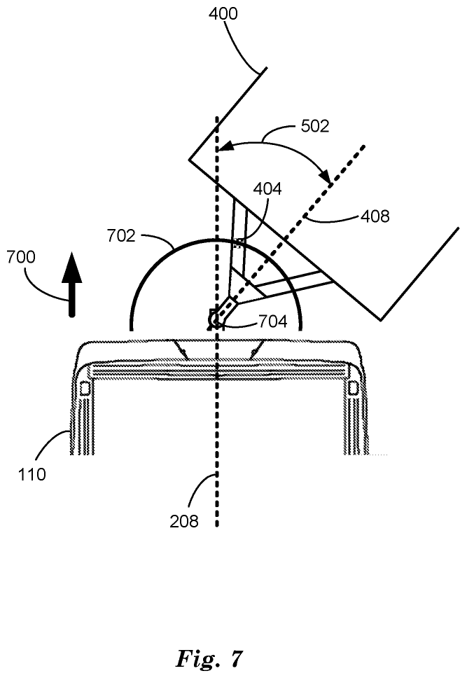

FIG. 7 is a diagram illustrating fiducial marker-based trailer angle estimation. Fiducial marker-based trailer angle estimation proceeds by operating vehicle 110 so as to cause the trailer 400 to rotate with respect to the vehicle 110. This can be accomplished by moving the vehicle backwards, e.g., backing, the vehicle 110 along a vehicle path parallel to the vehicle axis 210 in the direction indicated by arrow 700. Other techniques that can cause the trailer 400 to rotate with respect to vehicle 110 include operating the vehicle 110 forward while increasing or decreasing the steering angle, for example. While the trailer 400 is rotating with respect to the vehicle, computing device 115 acquires a plurality of images that include the fiducial marker 404 and determines poses for the fiducial marker in the plurality of images using image processing techniques discussed above in relation to FIG. 3. A fiducial marker pose includes both location and orientation. The location and orientation can be combined to determine an arc 702 with greater precision than location alone. The poses of the fiducial markers in the images are projected onto the reference plane 206 as discussed above in relation to FIG. 6, above, to determine an arc 702. The arc 702 can be determined by fitting a circle to the fiducial marker poses using a least squares algorithm, for example. A least squares algorithm is an algorithm for curve fitting that minimizes the squared differences between data points and a curve. Once the equation for the best-fit circle that includes arc 702 is determined, the center of rotation 704 can be determined.

Once the center of rotation 704 is determined, the location of the fiducial marker 404 in an image can be combined with the offset angle 606 to determine the location of the trailer axis 408. The location of the trailer axis 408 and the vehicle axis 210 are combined at the center of rotation 704 to determine a trailer angle 502 using simple trigonometry. For example, a line perpendicular to a segment of the vehicle axis 210 can be drawn to intersect a segment of the trailer axis 408 and trailer angle 502 determined by calculating the cosine of the trailer axis 408 segment divided by the vehicle axis 210 segment.

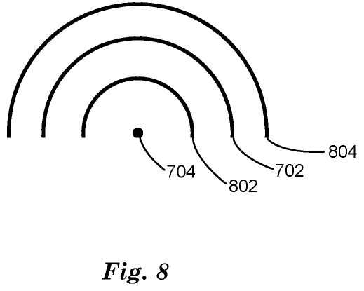

FIG. 8 is a diagram of a plurality of arcs 702, 802, 804. Because fiducial marker-based trailer angle estimation is based on a center of rotation 704, changes in the height of a trailer 400 do not cause the technique to fail. Changes in trailer 400 height caused by changes in hitch ball height can change the radius of the arc 702 but do not change the estimation of the center of rotation 704 or offset angle 606. Arc 802 is generated by plotting poses of fiducial marker 404 when height of trailer 400 is lower than height of trailer 400 when arc 702 is generated. Arc 804 is generated by plotting poses of fiducial marker 404 when height of trailer 400 is higher than the height of trailer 400 when arc 702 is generated. Determined center of rotation 704 is the same for arcs 702, 802, 804 despite changes in height of trailer 400.

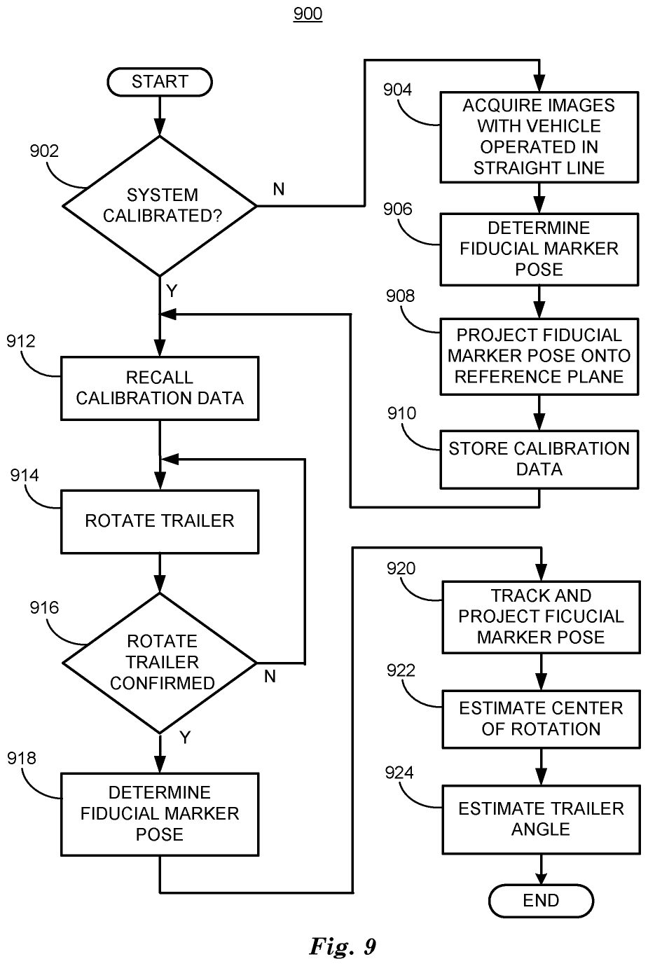

FIG. 9 is a flowchart, described in relation to FIGS. 1-8 of a process 900 fiducial marker-based trailer angle estimation. Process 900 can be implemented by a processor of a computing device 115, taking as input images acquired from a camera 202, executing commands, and outputting a trailer angle 502. Process 900 includes multiple blocks that can be executed in the illustrated order. Process 900 could alternatively or additionally include fewer blocks or can include the blocks executed in different orders.

Process 900 begins at block 902, where computing device 115 determines whether the fiducial marker-based trailer angle estimation system is calibrated. If the center of rotation 704 and offset angle 606 is stored in memory included in the computing device 115, process 900 passes to block 912. If the center of rotation 704 and offset angle 606 is not included in memory included in computing device 115, process 900 passes to block 904 to acquire the straight line images used to calibrate process 900.

At block 904 the computing device 115 operates the vehicle 110 in a straight line in a forward direction and acquires straight-line images as discussed above in relation to FIG. 6.

At block 906 the computing device 115 determines poses of fiducial markers 404 in the acquired straight line images as discussed in relation to FIG. 3, above.

At block 908 computing device 115 calibrates the fiducial marker-based trailer angle estimation system by combining the fiducial marker 404 poses determined at block 906. Fiducial marker 404 poses can be combined by averaging, for example. The combined fiducial marker pose can be projected onto the reference plane to determine the location of the fiducial marker 404 in real world coordinates and the offset angle 606 determined as discussed in relation to FIG. 6, above.

At block 910 computing device 115 stores the calibration data including offset angle 606 in memory included in the computing device 115.

At block 912 computing device 115 recalls the calibration data including the offset angle 606 from memory.

At block 914 computing device 115 operates vehicle 110 to cause the trailer 400 to rotate with respect to the vehicle 110 while acquiring images of the fiducial marker 404. As discussed above in relation to FIG. 7, operating the vehicle 110 by backing up can cause the trailer 400 to rotate.

At block 916 computing device 115 determines whether enough images of fiducial marker poses covering a sufficient rotation have been acquired. For example, acquiring 10 images of fiducial marker poses indicating a trailer 400 rotation through 20 degrees is sufficient. If the rotation is not sufficient, process 900 returns to block 912 to continue rotating the trailer and acquiring data. If the rotation distance and number of images is determined to be sufficient, trailer rotation is confirmed and process 900 passes to block 918.

At block 918 computing device 115 process images from camera 202 as discussed above in relation to FIG. 3 to determine a plurality of fiducial marker 404 poses in the images acquired at block 914 as the trailer 400 rotates.

At block 920 computing device 115 tracks and projects fiducial marker 404 poses by projecting the fiducial marker 404 poses determined at block 916 onto the reference plane and fitting the projected points to a circular arc 702 as discussed above in relation to FIG. 7.

At block 922 computing device 115 estimates a center of rotation 704 based on the fit circular arc 702 as discussed above in relation to FIG. 7.

At block 924 computing device 115 estimates a trailer angle 502 based on the center of rotation 704, the fiducial marker 404 offset angle 606 and the location of the fiducial marker 404 in an image acquired when the trailer has stopped rotating. Determining a trailer angle 502 in this fashion determines a trailer angle despite changes in trailer hitch height or longitudinal location with respect to a vehicle 110. As long as the same trailer 400 having the same fiducial marker 404 at the same location on the trailer is attached to the vehicle 110, process 900 will find the correct trailer angle 502 within reasonable tolerances, e.g., +/−1 degree despite changes in trailer 400 height. Following block 924 process 900 ends.

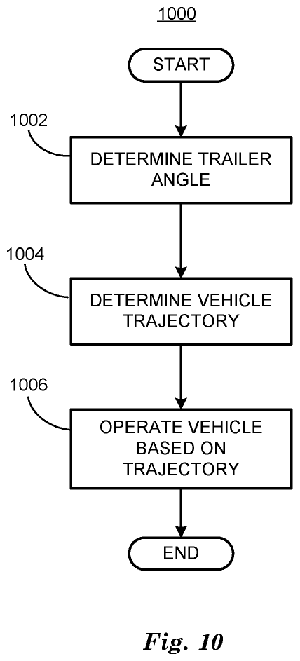

FIG. 10 is a flowchart, described in relation to FIGS. 1-9 of a process 1000 for operating a vehicle 110 based on estimating a trailer angle 502 using the fiducial marker-based trailer angle estimation system described in relation to FIG. 8. Process 1000 can be implemented by a processor of a computing device 115, taking as input image data that includes an object, executing commands, and operating a vehicle 110. Process 1000 includes multiple blocks that can be executed in the illustrated order. Process 1000 could alternatively or additionally include fewer blocks or can include the blocks executed in different orders.

At block 1002 process 1000 determines a trailer angle 502 using a fiducial marker-based trailer angle estimation system as described above in relation to FIG. 8.

At block 1004 process 1000 determines a trajectory for operating a vehicle 110 based on the trailer angle 502 determined at block 1002. For example, a vehicle 110 can have an attached trailer 400 that needs to be backed into a desired location, such as a garage, a parking spot or a boat launch. Once the trailer angle 502 is known, a simplified model of vehicle 110 and trailer 400 dynamics such as a bicycle model can be used to determine a vehicle path that will result in the trailer 400 being located at the desired location at the desired orientation. A bicycle model assumes that the vehicle 110 is a rigid platform with two wheels, with the front wheel being steered, while the trailer 400 is a rigid platform with one wheel, and the vehicle/trailer system is articulated at the hitch.

At block 1006 process 1000 operates the vehicle 110 based on the determined trajectory. Operating a vehicle 110 can include communicating commands from computing device 115 to controllers 112, 113, 114 to control one or more of vehicle powertrain, steering, and brakes to operate the vehicle 110 to cause the trailer 400 to move to the desired position. The vehicle trajectory is analyzed by computing device 115 to determine lateral and longitudinal accelerations to apply to the vehicle to cause the vehicle 110 and trailer 400 to travel along the trajectory. Following block 1006 process 1000 ends.

Computing devices such as those discussed herein generally each includes commands executable by one or more computing devices such as those identified above, and for carrying out blocks or steps of processes described above. For example, process blocks discussed above may be embodied as computer-executable commands.

Computer-executable commands may be compiled or interpreted from computer programs created using a variety of programming languages and/or technologies, including, without limitation, and either alone or in combination, Java™, C, C++, Python, Julia, SCALA, Visual Basic, Java Script, Perl, HTML, etc. In general, a processor (i.e., a microprocessor) receives commands, i.e., from a memory, a computer-readable medium, etc., and executes these commands, thereby performing one or more processes, including one or more of the processes described herein. Such commands and other data may be stored in files and transmitted using a variety of computer-readable media. A file in a computing device is generally a collection of data stored on a computer readable medium, such as a storage medium, a random access memory, etc.

A computer-readable medium (also referred to as a processor-readable medium) includes any non-transitory (i.e., tangible) medium that participates in providing data (i.e., instructions) that may be read by a computer (i.e., by a processor of a computer). Such a medium may take many forms, including, but not limited to, non-volatile media and volatile media. Instructions may be transmitted by one or more transmission media, including fiber optics, wires, wireless communication, including the internals that comprise a system bus coupled to a processor of a computer. Common forms of computer-readable media include, for example, RAM, a PROM, an EPROM, a FLASH-EEPROM, any other memory chip or cartridge, or any other medium from which a computer can read.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

The term “exemplary” is used herein in the sense of signifying an example, i.e., a candidate to an “exemplary widget” should be read as simply referring to an example of a widget.

The adverb “approximately” modifying a value or result means that a shape, structure, measurement, value, determination, calculation, etc. may deviate from an exactly described geometry, distance, measurement, value, determination, calculation, etc., because of imperfections in materials, machining, manufacturing, sensor measurements, computations, processing time, communications time, etc.

In the drawings, the same candidate numbers indicate the same elements. Further, some or all of these elements could be changed. With regard to the media, processes, systems, methods, etc. described herein, it should be understood that, although the steps or blocks of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claimed invention.

1. A system, comprising:
a computer that includes a processor and a memory, the memory including instructions executable by the processor to:
acquire images, including a first image and a second image of an object attached to a platform that is moving;
determine a first real world location of a fiducial marker included in the object by determining a first location of the fiducial marker in first pixel coordinates of the first image, and projecting the first pixel coordinates onto a reference plane;
determine a second real world location of a fiducial marker included in the object by determining a second location of the fiducial marker in second pixel coordinates of the second image, and projecting the second pixel coordinates onto the reference plane;
determine a center of rotation for the object by fitting the first and second real world locations of the fiducial marker to an arc; and
determine an angle of an axis the object with respect to an axis of the platform based on the center of rotation, a third location of the fiducial marker, and calibration data.

2. The system of claim 1, the instructions including further instructions determine the center of rotation for the object by fitting the first and second real world locations of the fiducial marker while moving the platform to change the angle of the axis of the object with respect to the axis of the platform.

3. The system of claim 2 the instruction including further instructions to determine the center of rotation by fitting the first and second real world locations of the fiducial marker to an arc using a least squares technique.

4. The system of claim 1, wherein the calibration data includes an offset angle between the location of the fiducial marker and the axis of the object.

5. The system of claim 4, the instruction including further instructions to, when it is determined that the calibration data does not exist, determine the calibration data by acquiring one or more images of the fiducial marker while moving the platform forward in a straight line to determine the offset angle between the location of the fiducial marker and the axis of the object.

6. The system of claim 1, wherein the axis of the object is parallel to a direction of forward motion and passes through the center of rotation.

7. The system of claim 1, wherein the axis of the platform is parallel to a direction of forward motion and passes through the center of rotation.

8. The system of claim 1, wherein the center of rotation is coincident with a point of attachment between the object and the platform.

9. The system of claim 1, wherein the real world locations of the fiducial marker are determined with respect to a reference plane specified parallel to a roadway or pavement surface upon which the platform moves.

10. The system of claim 1, wherein the platform is a vehicle and moving the platform includes the computer controlling one or more of vehicle powertrain, vehicle steering and vehicle brakes.

11. The system of claim 1, wherein the object is a vehicle trailer.

12. A method, comprising:
acquiring images, including a first image and a second image of an object attached to a platform that is moving;
determining a first real world location of a fiducial marker included in the object by determining a first location of the fiducial marker in first pixel coordinates of the first image, and projecting the first pixel coordinates onto a reference plane;
determining a second real world location of a fiducial marker included in the object by determining a second location of the fiducial marker in second pixel coordinates of the second image, and projecting the second pixel coordinates onto the reference plane;
determining a center of rotation for the object by fitting the first and second real world locations of the fiducial marker to an arc; and
determining an angle of an axis the object with respect to an axis of the platform based on the center of rotation, a third location of the fiducial marker, and calibration data.

13. The method of claim 12, further comprising determining the center of rotation for the object by fitting the first and second real world locations of the fiducial marker while moving the platform to change the angle of the axis of the object with respect to the axis of the platform.

14. The method of claim 13, further comprising determining the center of rotation by fitting the first and second real world locations of the fiducial marker to an arc using a least squares technique.

15. The method of claim 12, wherein the calibration data includes an offset angle between the location of the fiducial marker and the axis of the object.

16. The method of claim 15, further comprising, when it is determined that the calibration data does not exist, determining the calibration data by acquiring one or more images of the fiducial marker while moving the platform forward in a straight line to determine the offset angle between the location of the fiducial marker and the axis of the object.

17. The method of claim 12, wherein the axis of the object is parallel to a direction of forward motion and passes through the center of rotation.

18. The method of claim 12, wherein the axis of the platform is parallel to a direction of forward motion and passes through the center of rotation.

19. The method of claim 12, wherein the center of rotation is coincident with a point of attachment between the object and the platform.

20. The method of claim 12, wherein the real world locations of the fiducial marker are determined with respect to a reference plane specified parallel to a roadway or pavement surface upon which the platform moves.
